(19) United States
(12) Patent Application Publication
(10) Pub. No.: US 2020/0144911 A1
(43) Pub. Date: May 7, 2020

(54) CHARGE PUMP-BASED WIRELESS POWER RECEIVER

(71) Applicant: MAPS, INC., Seoul (KR)

(72) Inventors: Jong Tae HWANG, Seoul (KR); Hui Yong CHUNG, Seongnam-si (KR); Hyun Ick SHIN, Seoul (KR); Joon RHEE, Seoul (KR)

(73) Assignee: MAPS, INC., Seoul (KR)

(21) Appl. No.: 16/609,464

(22) PCT Filed: Feb. 20, 2018
(86) PCT No.: PCT/KR2018/002085

§ 371 Date: Oct. 30, 2019

(30) Foreign Application Priority Data
May 12, 2017 (KR) 10-2017-0059559
Jun. 22, 2017 (KR) 10-2017-0079252

(51) Int. Cl. H02M 3/07; H02J 50/12; H02J 50/80

(52) U.S. Cl. CPC H02M 3/07; H02J 50/80; H02J 50/12

(57) ABSTRACT

A wireless power receiver according to an embodiment includes: a resonator for receiving wireless power; a rectifier for rectifying the wireless power received from the resonator into a DC waveform; and a charge pump for receiving input of the rectified power from the rectifier, and reduces loss in the rectifier following the attenuation and output of the voltage of the input power.

### TECHNICAL FIELD

The present invention relates to a wireless power transmission system, and more particularly, to a direct-current (DC)-DC voltage converter for reducing rectifier loss and a wireless power receiving device including the same.

### BACKGROUND ART

A general direct-current (DC)-DC voltage converter, which is used in a wireless power transmission system, receives a DC voltage and steps the received DC voltage up or down to a stable voltage which is required at an output of the DC-DC voltage converter. In a rectifier for outputting a rectified DC voltage to the DC-DC voltage converter, driving loss and conduction loss occur. The driving loss is loss which occurs to drive a switch in the rectifier, and the conduction loss is loss which occurs in the switch. The conduction loss is proportional to the square of a current flowing in the switch and is proportional to resistance of the switch. In a wireless power receiver, a rectifier is a very important factor in determining power transfer efficiency so that it is important to maximize efficiency of the rectifier.

### DISCLOSURE

### Technical Problem

The present invention is directed to providing a wireless power receiver for maximizing power transmission efficiency by minimizing power loss of a wireless power receiver.

### Technical Solution

One aspect of the present invention provides a wireless power receiver including a resonator for receiving wireless power, a rectifier for rectifying the wireless power received from the resonator into a direct current (DC) waveform, and a charge pump for receiving the rectified power from the rectifier and attenuating and outputting a voltage of the received power, thereby reducing loss of the rectifier.

The charge pump may be located at a final output stage of the wireless power receiver and may supply the output voltage to a load. The charge pump may attenuate the voltage of the rectifier such that the output voltage becomes 1/N times the voltage of the rectifier (N is a positive real number). The charge pump may include one or more capacitors. The charge pump may not include an inductor.

The charge pump may include an input node for receiving a voltage of the rectifier as an input voltage, an output node for supplying an output voltage to a load, a first capacitor, a first switch connected to the input node and a first terminal of the first capacitor, a second switch connected to a second terminal of the first capacitor and the output node, a third switch connected to the first terminal of the first capacitor and the output node, and a fourth switch connected to a ground and the second terminal of the first capacitor. The charge pump may further include a second capacitor for connecting the output node to the ground.

The wireless power receiver may further include a charge pump control unit for detecting a voltage output from the rectifier and determining whether to operate the charge pump on the basis of the detected voltage of the rectifier to control the charge pump. The wireless power receiver may further include a communication unit for communicating with a wireless power transmitter, and the charge pump control unit may detect the voltage of the rectifier and control rectifier voltage information, which allows the detected voltage of the rectifier to be greater than the output voltage, to be transmitted to the wireless power transmitter through the communication unit such that the wireless power transmitter may adjust output power of a power amplifier.

### ADVANTAGEOUS EFFECTS

A circuit of a charge pump is constituted at a final output stage of a wireless power receiver such that power loss of a rectifier can be minimized to maximize power transfer efficiency of the wireless power receiver. For example, when the rectifier employs a metal oxide semiconductor field effect transistor (MOSFET) switch, loss can be resolved in inverse proportion to the square of N that is a voltage attenuation ratio, and, when the rectifier employs a passive element such as a diode, the loss can be resolved in inverse proportion to N.

Further, since the circuit of the charge pump employs only capacitors instead of inductors, bulky inductors may be eliminated. Therefore, a system occupying a small area may be implemented as well as no loss is consumed in the inductors such that it is possible to substantially achieve very high efficiency.

### DESCRIPTION OF DRAWINGS

FIG. 1 is a diagram illustrating a wireless power transmission system in which a low drop-out regulator (LDO) is constituted as a final output stage.

FIG. 2 is a diagram illustrating a wireless power transmission system in which a buck converter is constituted as a final output stage.

FIG. 3 is a diagram illustrating a variation in output current of a rectifier according to a voltage conversion ratio N.

FIG. 4 is a diagram illustrating a wireless power transmission system in which a charge pump is constituted as a final output stage according to an exemplary embodiment of the present invention.

FIG. 5 is a diagram illustrating an example of a charge pump circuit (a ½ attenuation circuit) having a voltage attenuation ratio of two according to an exemplary embodiment of the present invention.

### MODES OF THE INVENTION

The advantages and features of the present invention and the manner of achieving the advantages and features will become apparent with reference to the embodiments described in detail below together with the accompanying drawings. The present invention may, however, be implemented in many different forms and should not be construed as being limited to the embodiments set forth herein, and the embodiments are provided such that this disclosure will be thorough and complete and will fully convey the scope of the present invention to those skilled in the art, and the present invention is defined by only the scope of the appended claims. The same reference numerals refer to the same components throughout this disclosure.

In the following description of the embodiments of the present invention, if a detailed description of related known functions or configurations is determined to unnecessarily obscure the gist of the present invention, the detailed description thereof will be omitted herein. The terms described below are defined in consideration of the functions in the embodiments of the present invention, and these terms may be varied according to the intent or custom of a user or an operator. Therefore, the definitions of the terms used herein should follow contexts disclosed herein.

Combinations of each block of the accompanying block diagrams and each step of the accompanying flowcharts may be performed by computer program instructions (an execution engine), and these computer program instructions may be embedded in a processor of a general purpose computer, a special purpose computer, or other programmable data processing equipment. Thus, these computer program instructions, which are executed through a processor of a computer or other programmable data processing equipment, produce tools for performing a function described in each block of the block diagrams or in each step of the flowcharts.

These computer program instructions may also be stored in a computer usable or readable memory which can be oriented toward a computer or other programmable data processing equipment so as to implement the function in a particular manner. Therefore, the computer program instructions stored in the computer usable or readable memory may produce an article of manufacture containing an instruction tool for performing the function described in each block of the block diagrams or in each step of the flowcharts.

Further, the computer program instructions can also be mounted on a computer or other programmable data processing equipment. Therefore, the computer program instructions which serve as a computer or other programmable data processing equipment by performing a series of operation steps on the computer or the other programmable data processing equipment to produce a computer-implemented process may also provide steps for executing the functions described in each block of the block diagrams and in each step of the flowcharts.

Further, each block or each step may represent a module, a segment, or a part of a code, which includes one or more executable instructions for performing specified logical functions, and it should be noted that, in some alternative embodiments, the functions described in the blocks or steps may occur out of sequence. For example, two blocks or steps shown in succession may in fact be substantially executed at the same time, and the two blocks or steps may also be executed in the reverse order of the corresponding function as necessary.

Hereinafter, exemplary embodiments of the present invention will be described in detail with reference to the accompanying drawings. However, the exemplary embodiments of the present invention, which will be illustrated below, may be modified in various other forms, and the scope of the present invention is not limited to the exemplary embodiments described below. The exemplary embodiments of the present invention are provided to fully convey the present invention to those skilled in the art to which the present invention pertains.

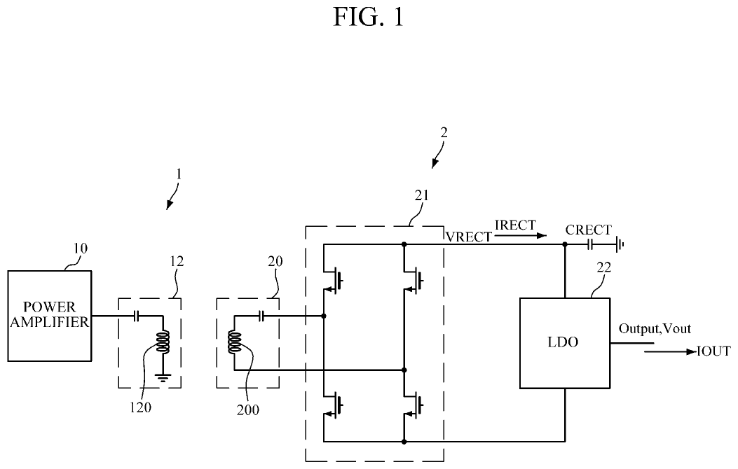

FIG. 1 is a diagram illustrating a wireless power transmission system in which a low drop-out regulator (LDO) is constituted as a final output stage.

Referring to FIG. 1, the wireless power transmission system includes a transmitter 1 and a receiver 2. The transmitter 1 includes a power amplifier 10 and a resonator 12 comprised of an antenna 120. Like the transmitter 1, the receiver 2 includes a resonator 20 comprised of an antenna 200. A rectifier 21 is required for the receiver 2 to convert an alternating-current (AC) signal received from the resonator 20 into a DC signal. FIG. 1 illustrates an active rectifier comprised of four metal oxide semiconductor field effect transistor (MOSFET) switches. The rectifier may be comprised using a diode. However, it is generally known that efficiency of an active rectifier using a MOSFET is higher. A voltage which undergoes a DC conversion by rectifier 21 and is output is called a rectifier voltage VRECT. An LDO 22 is provided to receive the rectifier voltage VRECT and convert the received rectifier voltage VRECT into an elaborate DC voltage. The term “LDO” is an abbreviation of “low drop-out regulator.” The LDO 22 is an element which receives a DC voltage and steps the received DC voltage down to another DC voltage, which is desired, to output the another DC voltage and performs a linear operation. The LDO 22 is used to generate an output voltage VOUT from the rectifier voltage VRECT and finally output an output current IOUT which is necessary at a load.

Since the LDO 22 is a linear element, when the rectifier voltage VRECT is substantially equal to the output voltage VOUT, maximum power conversion efficiency is exhibited. When it is controlled to be VRECT=VOUT, very high efficiency may be achieved. Otherwise, power loss in the LDO 22 occurs as in Equation 1 below so that in a manner using the LDO 22, it may be said that an advantage and a disadvantage are clear.

Loss=(VRECT−VOUT)×LOUT [Equation 1]

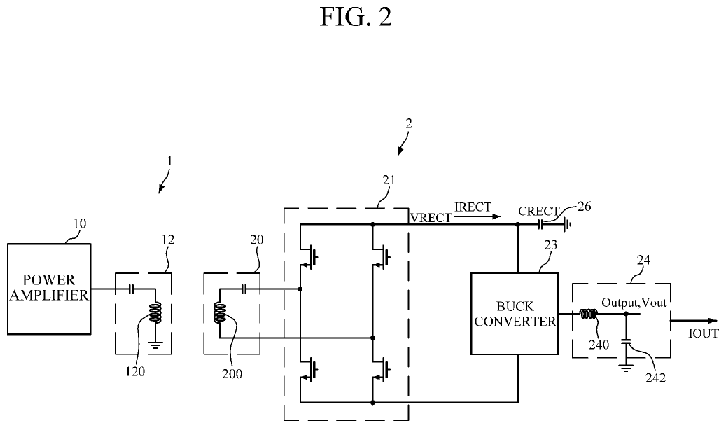

FIG. 2 is a diagram illustrating a wireless power transmission system in which a buck converter is constituted as a final output stage.

As shown in FIG. 2, even when the rectifier voltage VRECT is significantly different from the output voltage VOUT, a method which achieves high power conversion efficiency is using a buck converter 23 at an output terminal. The buck converter 23 is a circuit for converting an input voltage into a low output voltage using a switching element. Even when a voltage difference between the rectifier voltage VRECT and the output voltage VOUT is large, the buck converter 23 may achieve relatively high efficiency.

However, in order for the buck converter 23 to operate, such a method requires a low pass filter 24 comprised of an inductor 240 and a capacitor 242 at an output terminal. Since the low pass filter 24 is necessary, required components are increased as compared with the LDO method to increase manufacturing cost, and power loss occurring due to a parasitic resistance component of the inductor 240 acts as the biggest disadvantage. Further, since a circuit of the buck converter 23 is more complicated than that of the LDO and more elements are required, when the buck converter 23 is implemented as an integrated circuit, it is also disadvantageous that an area occupied by the buck converter 23 is large.

Meanwhile, since VRECT=2VOUT when the voltage conversion ratio N is 2 in the buck converter 23, an average current (IRECT, average) of the rectifier for generating the same output power is only half of the output current IOUT.

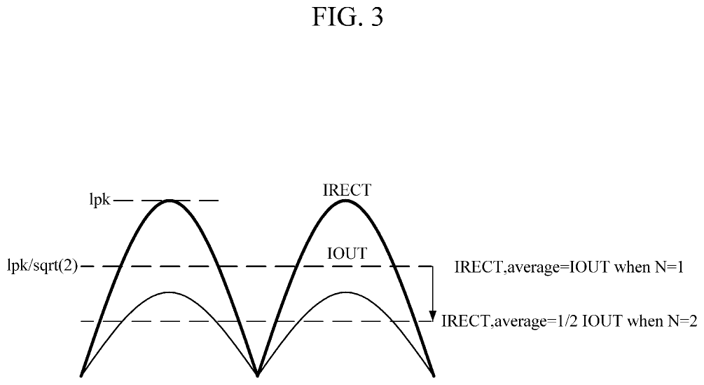

FIG. 3 is a diagram illustrating a variation in output current of a rectifier according to a voltage conversion ratio N.

Referring to FIGS. 2 and 3, the output current IRECT of the rectifier is generally changed into a pulse current in the form of a half-wave sine wave and smoothed by a capacitor (CRECT) 26 such that an average current (IRECT, average) of the rectifier is averagely supplied to the buck converter 23 as Equation 2 below.

$$IRECT , average = \frac{Ipk}{\sqrt{2}} \qquad [ Equation 2 ]$$

When N=2, the average current (IRECT, average) of the rectifier is reduced to half of the output current IOUT. Generally, conduction loss of a switch of the rectifier is proportional to the square of a current flowing in the switch and is proportional to a resistance component of the switch. Consequently, when an average current of the rectifier is reduced by as much as half, the conduction loss of the switch is reduced by as much as ¼ times. Thus, when there is no loss of the buck converter 23 and N=2, theoretical efficiency which is 4 times better than LDO may be achieved. However, efficiency of the buck converter 23 is actually decreased as the voltage conversion ratio N is increased, efficiency gain does not substantially occur, and, even when the rectifier voltage VRECT is varied, only power consumption is kept constant. That is, even when a voltage difference between the rectifier voltage VRECT and the output voltage VOUT occurs, a system of which efficiency is not reduced is implemented.

As a result, when the voltage difference between the rectifier voltage VRECT and the output voltage VOUT is large, it is correct that the conduction loss of the switch of the rectifier is reduced. However, in the LDO, since loss of the LDO occurs according to Equation 1, the rectifier voltage VRECT cannot be increased, and, since the efficiency of the buck converter 23 is reduced, it becomes a state in which no significant gain is obtained in spite of the loss of the rectifier being reduced. Further, the inductor 240 being required in the buck converter 23 acts as another disadvantage.

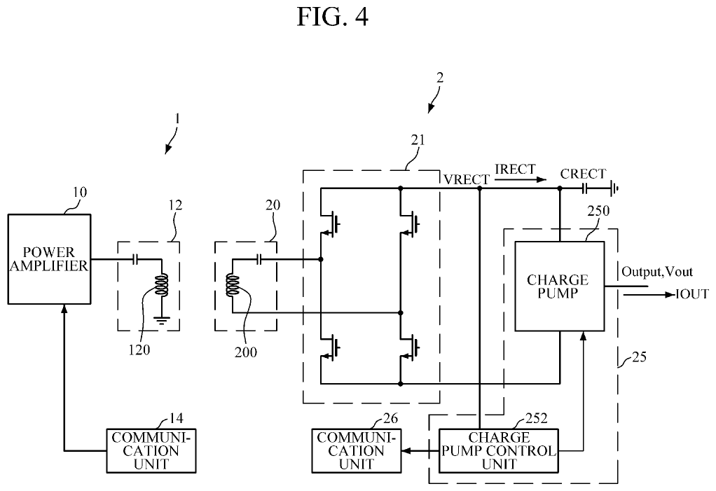

FIG. 4 is a diagram illustrating a wireless power transmission system in which a charge pump is constituted as a final output stage according to an exemplary embodiment of the present invention.

In order to solve the above-described problems of the LDO and the buck converter with reference to FIGS. 2 and 3, as shown in FIG. 4, using a charge pump 250 with a voltage attenuation ratio N as a final output stage is proposed. The charge pump 250 is a switching circuit which outputs a voltage that is higher or lower than an input using a switch element and a capacitor. In this case, an attenuation charge pump for stepping a voltage down lower than an input will be employed. When a voltage attenuation ratio is N and a condition of VRECT=N×VOUT is satisfied, the charge pump 250 maintains high power conversion efficiency as well as an effect occurring in which, owing to such a characteristic, the rectifier voltage VRECT is N times higher than the output voltage VOUT such that a rectifier current IRECT is N times smaller than the output current IOUT. Further, since the charge pump 250 employs only capacitors instead of inductors, bulky inductors may be eliminated. Therefore, a system occupying a small area may be implemented as well as no loss being consumed in the inductors such that it is possible to achieve substantially very high efficiency.

Hereinafter, a configuration of the receiver 2 including the charge pump 250 will be described with reference to FIG. 4. Referring to FIG. 4, the receiver 2 may include the resonator 20, the rectifier 21, and a voltage adjusting part 25 and may further include a communication unit 26. The voltage adjusting part 25 may include the charge pump 250 and may further include a charge pump control unit 252.

The resonator 20 receives wireless power from the transmitter 1, and the rectifier 21 rectifies the wireless power received from resonator 20 into a DC waveform. The charge pump 250 receives the rectified power from the rectifier 21 and attenuates and outputs a voltage of the received power, thereby reducing loss of the rectifier 21. The charge pump 250 is located at a final output stage of the receiver 2 and applies the output current IOUT to the load. The charge pump 250 attenuates a voltage of the rectifier such that output voltage VOUT is 1/N times the rectifier voltage VRECT. In this case, N may be a positive real number including a positive integer. The charge pump 250 includes one or more capacitors to convert power. In this case, since the charge pump 250 does not include an inductor, a circuit configuration may be simplified.

The charge pump control unit 252 detects the rectifier voltage VRECT output from the rectifier 21 and determines whether to operate the charge pump 250 on the basis of the detected rectifier voltage VRECT to control the charge pump 250. For example, when the rectifier voltage VRECT is higher than a reference voltage, the charge pump 250 is activated, and, when the rectifier voltage VRECT is lower than the reference voltage, the charge pump 250 is deactivated.

The communication unit 26 of the receiver 2 communicates with a communication unit 14 of the transmitter 1. In this case, the charge pump control unit 252 detects the rectifier voltage VRECT and controls rectifier voltage information, which allows the detected rectifier voltage VRECT to be greater than the output voltage VOUT, to be transmitted to the transmitter 1 through the communication unit 26 such that the transmitter 1 adjusts output power of the power amplifier 10.

The charge pump control unit 252 may detect the rectifier voltage VRECT and communicate through the communication unit 26 to control the power of the transmitter 1, thereby achieving a condition of VRECT=N×VOUT. Therefore, as compared with a method using the LDO, the average current (IRECT, average) of the rectifier may be reduced by as much as N times. When such control is performed, since the charge pump 250 operates in a state of nearly 100% conversion efficiency, efficiency reduction of the charge pump 250 is hardly considered, and only loss of the rectifier 21 affects efficiency of the receiver 2. Since such a method controls the rectifier voltage VRECT to be N times higher than the output voltage VOUT as compared with the method using the LDO, the output current IRECT of the rectifier is N times smaller than that of the method using LDO such that conduction loss of a switch of the rectifier 21 is reduced by as much as 1/N^{2 times.}

When the method using LDO performs the control to achieve a condition of VRECT=VOUT well so that conversion efficiency of the LDO becomes 100%, and power consumption of the rectifier 21 is one, total power consumption of the receiver 2 becomes one. When a buck converter is used, power consumption is greater than one due to power consumption of an inductor. On the other hand, when the charge pump 250 is used and controls to achieve a condition of VRECT=N×VOUT, the power consumption is reduced by as much as 1/N² times so that best power conversion efficiency among the three cases may be satisfied.

However, since actual power conversion efficiency of the charge pump is not 100%, the power conversion efficiency may be lower than 100%. It is impossible to achieve power conversion efficiency of 100% in the actually implementable charge pump 250, but it is possible to implement the charge pump 250 to achieve power conversion efficiency of late 90%. Therefore, even when the actual power conversion efficiency of the charge pump is considered, since loss reduction of the rectifier 21 is significantly high, overall efficiency of the receiver 2 becomes very high.

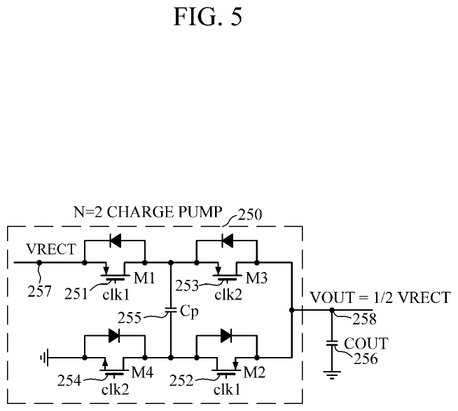

FIG. 5 is a diagram illustrating an example of a charge pump circuit (a ½ attenuation circuit) having a voltage attenuation ratio of 2 according to an exemplary embodiment of the present invention.

Referring to FIG. 5, when N, which is a voltage attenuation ratio, is two, the charge pump 250 may include an input node 257, an output node 258, a first capacitor Cp 255, a switch M1 251, a switch M2 252, a switch M3 253, and a switch M4 254 and may further include a second capacitor COUT 256.

The input node 257 receives the rectifier voltage VRECT as an input voltage, and the output node 258 supplies the output voltage VOUT to the load. The switch M1 251 is connected to the input node 257 and a first terminal of the first capacitor Cp 255, and the switch M2 252 is connected to a second terminal of the first capacitor Cp 255 and the output node 258. The switch M3 253 is connected to the first terminal of the first capacitor Cp 255 and the output node 258, and the switch M4 254 is connected to a ground and the second terminal of the first capacitor Cp 255. The second capacitor COUT 256 connects the output node 258 to the ground.

When the switch M1 251 and the switch M2 252 are turned on, the switch M1 251 and the switch M2 252 operate to supply energy to the load through the first capacitor Cp 255. When the switch M3 253 and the switch M4 254 are turned on, the switch M3 253 and the switch M4 254 operate to achieve VRECT=2VOUT. Therefore, the switching operations are repeatedly performed to implement a stable ½ attenuation circuit. When such a circuit is used, conduction loss of the rectifier is reduced by as much as ¼.

In the example of FIG. 5, the charge pump 250 may operate in two phases so as to generate the output voltage VOUT which is ½ of the rectifier voltage VRECT. When the switch M1 251 and the switch M2 252 are turned on, the first capacitor Cp 255 and the second capacitor COUT 256 are connected in series between the rectifier voltage VRECT and the ground in the first phase. When the switch M1 251 and the switch M2 252 are turned on, the first capacitor Cp 255 is not substantially charged, and the second capacitor COUT 256 is charged in advance so as to allow the output voltage VOUT to become VRECT/2 across the second capacitor COUT 256. Assuming that a capacitance value of the first capacitor Cp 255 is similar to that of the second capacitor COUT 256, the second capacitor COUT 256 is charged to produce a voltage of VRECT/2 across the second capacitor COUT 256. Thus, the output node 258 has the voltage of VRECT/2.

Then, when the switch M3 253 and the switch M4 254 are turned, the first capacitor Cp 255 (which is now charged to the voltage of VRECT/2) and the second capacitor COUT 256 are now electrically parallel to each other between the output node 258 and the ground in the second phase, and the rectifier voltage VRECT is now blocked. Thus, since either or both of the first capacitor Cp 255 and the second capacitor COUT 256 are discharged through the output node 258, the output voltage VOUT may be maintained at the voltage of VRECT/2.

As can be seen from FIGS. 4 and 5, in order for a variation in voltage, the charge pump 250 requires only the first capacitor Cp 255 and the second capacitor COUT 256 so that a system may be implemented very simply and unnecessary power consumption as in the inductor of the buck converter does not occur.

A kind of example to help understand the present invention is shown in FIG. 5, and a charge pump having various types of N may be implemented by adjusting a switch configuration and the number and values of capacitors. In this case, N may not necessarily be an integer. For example, a charge pump having a real number such as N=1.5 or 1.33 may be implemented.

Hereinbefore, it has been described that the rectifier using the MOSFET switch is focused and it has been described how loss is reduced in the rectifier. When a rectifier is implemented using a passive element, such as a diode, instead of a MOSFET switch, conduction loss of the rectifier is proportional to a magnitude of a current. Thus, when the MOSFET switch is used so that loss is resolved in inverse proportion to N², the loss is resolved in inverse proportion to N when a passive element such as a diode is used.

Hereinbefore, the present invention has been described by focusing on the exemplary embodiments. It can be understood by those skilled in the art to which the present invention pertains that the present invention can be implemented in modified forms without departing from the essential feature of the present invention. Therefore, the disclosed embodiments should be considered as illustrative rather than determinative. The scope of the present invention is defined by the appended claims rather than by the foregoing description, and all differences within the scope of equivalents thereof should be construed as being included in the present invention.

1. A wireless power receiver comprising:
a resonator configured to receive wireless power;
a rectifier configured to rectify the wireless power received from the resonator into a direct current (DC) waveform; and
a charge pump configured to receive the rectified power from the rectifier and attenuate and output a voltage of the received power, thereby reducing loss of the rectifier.

2. The wireless power receiver of claim 1, wherein the charge pump is located at a final output stage of the wireless power receiver and supplies the output voltage to a load.

3. The wireless power receiver of claim 1, wherein the charge pump attenuates the voltage of the rectifier such that the output voltage becomes 1/N times the voltage of the rectifier (N is a positive real number).

4. The wireless power receiver of claim 1, wherein the charge pump includes one or more capacitors.

5. The wireless power receiver of claim 4, wherein the charge pump excludes an inductor.

6. The wireless power receiver of claim 1, wherein the charge pump includes:
an input node configured to receive a voltage of the rectifier as an input voltage;
an output node configured to supply an output voltage to a load;
a first capacitor;
a first switch connected to the input node and a first terminal of the first capacitor;
a second switch connected to a second terminal of the first capacitor and the output node;
a third switch connected to the first terminal of the first capacitor and the output node; and
a fourth switch connected to a ground and the second terminal of the first capacitor.

7. The wireless power receiver of claim 6, wherein the charge pump further includes a second capacitor configured to connect the output node to the ground.

8. The wireless power receiver of claim 1, further comprising a charge pump control unit configured to detect a voltage output from the rectifier and determine whether to operate the charge pump on the basis of the detected voltage of the rectifier to control the charge pump.

9. The wireless power receiver of claim 8, further comprising a communication unit configured to communicate with a wireless power transmitter,
wherein the charge pump control unit detects the voltage of the rectifier and controls rectifier voltage information, which allows the detected voltage of the rectifier to be greater than the output voltage, to be transmitted to the wireless power transmitter through the communication unit such that the wireless power transmitter adjusts output power of a power amplifier.
